(19) United States
(12) Patent Application Publication
(10) Pub. No.: US 2006/0126275 A1
(43) Pub. Date: Jun. 15, 2006

(54) Bottom folder for carton with folded-in gusset tips

(75) Inventors: Peter Kortsmit, Mahtomedi, MN (US); Tommy Ljungstrom, Hoor (SE)

Correspondence Address: TETRA PAK US INTELLECTUAL PROPERTY DEPARTMENT;TETRA PAK INC., 101 COPORATE WOODS PARKWAY, VERNON HILLS, IL, 60061, US

(73) Assignee: Tetra Laval Holdings & Finance, S.A., Pully (CH)

(21) Appl. No.: 11/011,690

(22) Filed: Dec. 14, 2004

(51) Int. Cl. H02B 1/00

(52) U.S. Cl. 361/600

(57) ABSTRACT

A bottom folding assembly is used to form a package having a bottom wall with in-folded gusset tips. The assembly is configured to infold the bottom gusset panels, leading panel and trailing panel of a carton and to in-fold the gusset panel tips of the bottom wall for forming a sealed carton bottom. The bottom folding assembly includes a rotating drive shaft mounted transverse to a turret plane and spaced from a periphery of a turret path. A pair of opposing rotating members are disposed on either side of the rotational path of the turret and are operably mounted to the drive shaft. The rotating members are configured to rotate in a plane that is transverse to the turret plane. A pair of retaining members are operably mounted to the rotating drive shaft and are configured to rotate with the shaft. The retaining members are configured to rotate into an interior of the package and engage the gusset panel tips from the interior of the package. When a carton is positioned on the mandrel and passes the folding assembly, the opposing rotating members contact the gusset panels, urging the gusset panels inwardly. Concurrently, the retaining members engage the gusset tips to prevent the gusset tips from folding inwardly with the gusset panels and folding the gusset panel tips in a direction opposite of the gusset panels. A form, fill and seal machine having the bottom folding assembly is also disclosed.

### BACKGROUND OF THE INVENTION

The present invention pertains to a folding device for carton bottoms. More particularly, the present invention pertains to an apparatus for in-folding carton bottoms having folded-in gusset tips.

One common form of container for milk, juice and the like is the gable top carton. Recently, packaging technology has made enormous strides vis-à-vis these gable top cartons, as well as other types of packages. At present, technology permits packaging perishable food items for non-refrigerated extended shelf lives. These packages provide the ability to bring these food items into parts of the world that have limited transportation, distribution and storage infrastructure.

In view of that, efforts have been directed to increasing the ability to maintain high levels of cleanliness in forming, filling and sealing these containers to provide the highest quality product and to provide the greatest product shelf life. And, in conjunction with this, the demands on packaging machines have become greater, in particular, relative to operating speeds. Such machines must form, fill and seal packages, in a sterile environment, at high operating speeds.

In order to maintain the integrity of the package after it is filled and sealed, advanced technologies have been applied to the carton materials, as well as the processing operations. Many such packaging materials are formed from paperboard or fiberboard-based materials formed in a composite structure. Typically, one or more layers, such as polymeric coatings, foil coatings and the like, are applied to the paperboard or fiberboard substrate to reduce or eliminate the gas and liquid permeability of the substrate material.

It has been found that one avenue for promoting an environment that reduces the shelf life is wicking of the food product into the package material. Wicking occurs at the edges of the material that are exposed to the food product. Typically, wicking occurs at the raw or exposed edges of the bottom wall panels as they are folded to form the bottom wall. To this end, it has been found desirable to reduce the amount or extent of exposed edges, and in particular at the bottom wall. It has also been found that foil at the tips of the gussets (the in-folded triangular panels) can crack thus exposing the paperboard substrate.

One package that has affected such a reduction is disclosed in U.S. Pat. No. 6,328,204 to Stacy-Ryan and an apparatus to form such an over-folded bottom is disclosed in U.S. Pat. No. 6,385,950 to Anderson, both of which patents are commonly assigned with the present application and are incorporated herein by reference. While this over-folded bottom served to “cover” the exposed edge from the bottom front or rear panel, the infolded side panels (those panels that form the triangles when folded in) have edges that can remain exposed.

A package that overcomes these drawbacks is disclosed in copending U.S. patent application Ser. No. 10/______, entitled “Carton With Folded-In Gusset Tips”, filed on even date herewith and commonly owned with the present application and incorporated herein by reference. However, no machines are known for carrying out the folded in gusset tips of the carton.

Accordingly, there exists a need for a carton bottom folding device for folding cartons having bottoms with folded-in gusset tips. Desirably, such a device can be fitted within known form, fill and seal machines. Desirably, such a folding device can accommodate carton folding operations at the operating speeds of known filling machines

### BRIEF SUMMARY OF THE INVENTION

A bottom folding assembly is disclosed for forming a package having a bottom wall with in-folded gusset tips. The bottom folding assembly is configured to infold the bottom gusset panels, leading panel and trailing panel of a carton and to in-fold the gusset panel tips of the bottom wall for forming a sealed carton bottom. The folding assembly is disposed in a form, fill and seal packaging machine. The package is disposed on a turret that rotates in a path that defines a plane.

The bottom folding assembly includes a rotating drive shaft mounted transverse to the turret plane and spaced from a periphery of the turret path. A pair of opposing rotating members are disposed on either side of the rotational path of the turret. The member are operably mounted to the drive shaft and are configured to rotate in a plane that is transverse to the turret plane.

A pair of gusset tip retaining members are operably mounted to the rotating drive shaft to rotate with the shaft. A portion of each of the retaining members rotates into an interior of the package and engages the gusset panel tips from the interior of the package. When a carton is positioned on the mandrel and passes the folding assembly, the opposing rotating members contact the gusset panels, urging the gusset panels inwardly. At the same time, the retaining members engage the gusset tips, to prevent the gusset tips from folding inwardly with the gusset panels. This folds the gusset panel tips in a direction opposite of the gusset panels.

The retaining members are configured as having a mount fixedly mounted to the shaft and a depending extension element for rotation into the interior of the carton. The depending extension is formed at an angle to the vertical, extending outwardly from a distal end of the extension. This provides a smooth transition as the retaining member is rotated out of the carton. The retaining member ends rotate to define a circle that has a radius that is smaller than the distance from the shaft to the rotating fingers.

A preferred folder also includes a tucking assembly disposed between the opposing rotating members and between the pair of retaining members. The tucking assembly is also mounted to the drive shaft for rotating in a plane transverse to the plane of the rotating members and parallel to the turret plane. The tucking assembly contacts the bottom trailing flap, urging the bottom trailing flap inwardly, over the gusset panels and the folded gusset panel tips.

A form, fill and seal packaging machine having the bottom panel folder is also disclosed.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a perspective view of a form, fill and seal packaging machine having a bottom folder embodying the principles of the present invention that is configured to form a carton having folded-in gusset tips;

FIG. 2 is a perspective view of an exemplary carton having folded in gusset tips;

FIG. 3 is a view of the bottom wall of the carton as viewed from the inside of the carton;

FIG. 4 is a view of the bottom of the carton as the gusset panels are being folded inward and as the gusset tip is urged outward as in-folding occurs;

FIG. 5 is a cross-sectional view taken along line 5-5 of FIG. 4;

FIG. 6 is a further view of the bottom of the carton, similar to FIG. 4, showing the gusset panels folded further inward (than FIG. 4) and as the gusset tips are further urged or held outward as in-folding occurs;

FIG. 7 is a cross-sectional view taken along line 6-6 of FIG. 5;

FIG. 8 is a view of the carton bottom with the leading panel removed for clarity of illustration, showing the folded-in gusset tips and the tab panel;

FIG. 9 is a plan view of a blank for the carton;

FIG. 10 is perspective view of the carton bottom panel folder, the folder being shown with a carton moving between the folder fingers and shown with the gusset retaining members rotating into the end of the interior portion of the carton;

FIG. 11 is an illustration of the top of the folder and carton as viewed in FIG. 10;

FIG. 12 is a next view in sequence after FIG. 10 showing the gusset being held or pulled outward by the gusset retaining members;

FIG. 13 is an illustration of the top of the folder and carton as viewed in FIG. 12;

FIG. 14 is a next view in sequence after FIG. 12 showing the gusset panels folded and the trailing panel being folded down onto the gusset and leading panels;

FIG. 15 is an illustration of the top of the folder and carton as viewed in FIG. 14; and

FIG. 16 is a side view of the folding station;

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

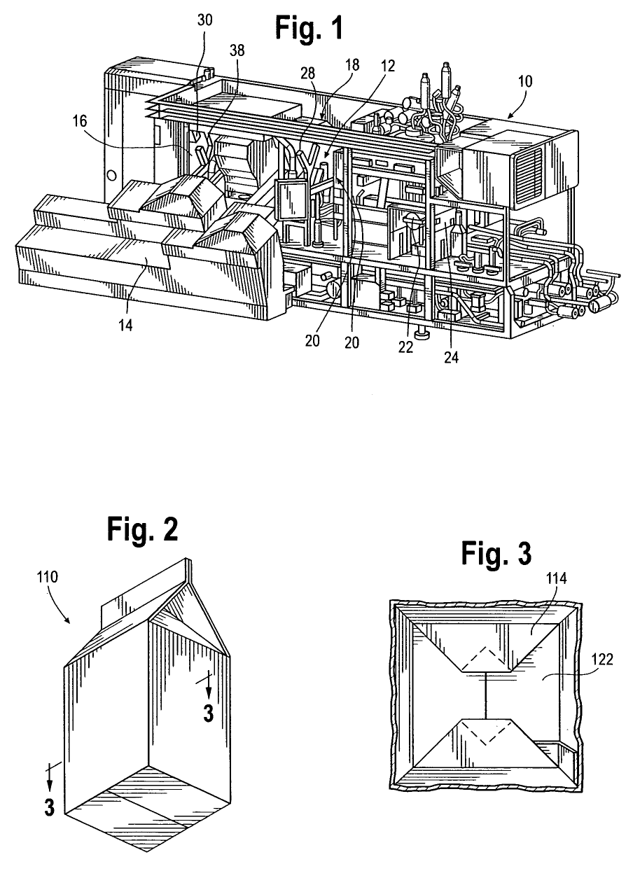

Referring now to the figures, and in particular to FIG. 1, there is shown a form, fill and seal packaging machine 10 that includes a bottom folding assembly 12 in accordance with the principles of the present invention. One example of a packaging machine (without the present bottom folding assembly) is disclosed in U.S. Pat. No. 6,012,267 to Katsumata which patent is incorporated herein by reference.

The packaging machine 10 includes generally, a carton magazine 14 for storing flat, folded carton blanks, a carton erection station 16 and a bottom forming and sealing station 18. The bottom folding assembly 12 is formed as part of the bottom forming and sealing station 18.

The machine 10 can further include a sterilization station 20 for sterilizing the cartons and further includes a filling station 22 at which the cartons C are filled with product. Following the filling station 22, the carton top panels are pre-folded and subsequently folded and sealed at a top folding and sealing station 24. The cartons C are then off loaded from the form, fill and seal packaging machine 10. The packaging machine 10 illustrated includes a conveyor 26 for transporting a series of cartons to and through each of the stations.

At the bottom forming and sealing station 18, the carton C is loaded onto a mandrel 28 that rotates through a plurality of stations (or substations) at which the panels are prefolded at the panel creases. The bottom end portion of the carton C is then heated so that the polymeric coating on the carton softens. The panels are then folded with the side or triangular gusset panels 114 folded inward and the carton leading 116 and trailing 118 panels folded over the gusset panels 114. As part of the leading and trailing panel 116, 118 folding, a sixth or tab panel 120 is folded outward (to lie between the leading 116 and trailing 118 panels) to eliminate an area of exposure of raw edge material to the product in the package.

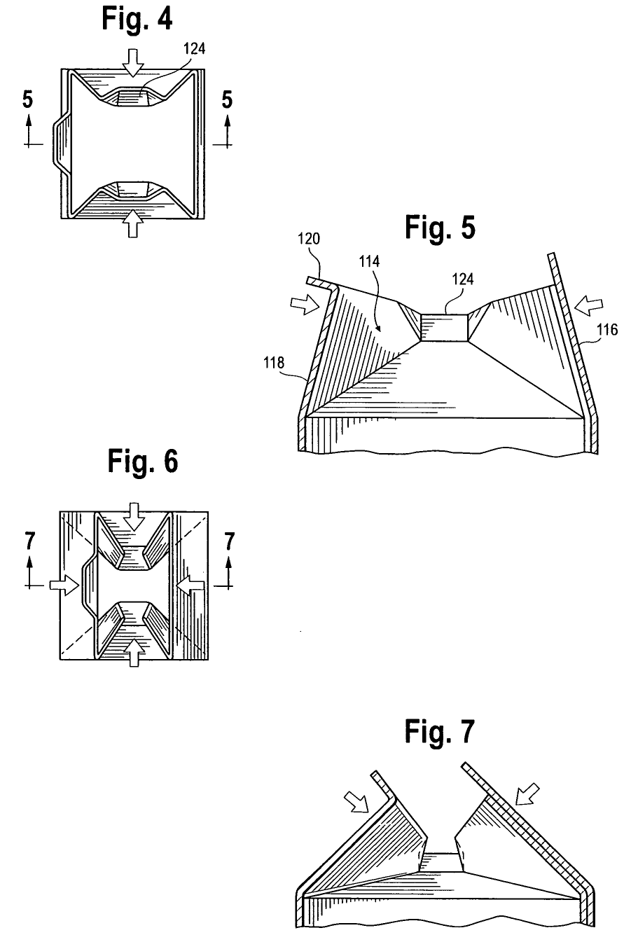

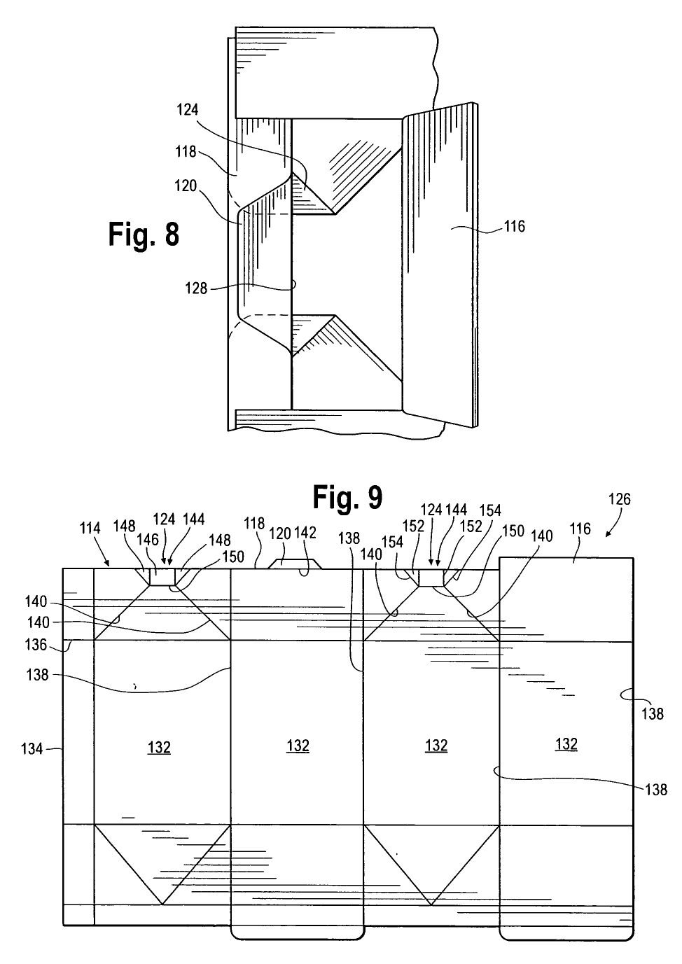

A carton 110 (formed by the present bottom folder 12) in which the bottom wall 122 has folded-in gusset tips 124 is shown generally in FIGS. 2-9. The carton C is disclosed in copending U.S. patent application Ser. No. 10/______, entitled “Carton With Folded-In Gusset Tips”, filed on even date herewith and commonly owned with the present application, and incorporated herein by reference.

FIGS. 3-8 illustrate the lower portion of the carton 110 and FIG. 9 illustrates a blank 126 that is configured for forming the bottom having folded-in gusset tips. The bottom wall 122 is formed from the in-folded side gusset panels 114 and the front and rear or leading and trailing 116, 118 panels. As seen in FIG. 2, as viewed from the inside of the carton, the tips 124 of the infolded triangular or gusset panels 114 are folded over or folded in, so that they lie under the triangular panels 114, between the panels 114 and the leading and trailing bottom panels 116, 118. The gusset panels 114 thus appear to have a truncated triangular shape, and define a folded over edge (indicated at 128). The tab or sixth panel 120 is folded over so that the raw or uncoated edge of the trailing panel 118 is also outside of the product storage or wetted region.

The blank 126 for this package has a plurality of bottom panels (specifically the gusset panels 114, the leading panel 116 and the trailing panel 118), a plurality of side panels 132, a sealing panel 134 and the sixth panel or tab 120. Each of the bottom panels 114-118 is partitioned from a corresponding side panel 132 by a horizontal score line 136. Each of the bottom panels 114-118 is partitioned from adjacent bottom panels by vertical score lines 138.

The bottom gusset panels 114 each have diagonal score lines 140 for folding the bottom panels 114-118 inward during the bottom wall 122 forming process. The sixth panel or tab 120 is partitioned from bottom panel by a horizontal score line 142. In this package blank 126, the major diagonal score lines 140 terminate at a folding region 144 that includes a rectangular area 146 having smaller triangular areas 148 adjacent to the sides of the rectangular area 146. The areas 146, 148 are defined by a first horizontal score line 150 contiguous with a pair of spaced apart vertical score lines 152. The major diagonal score lines 140 terminate at the corners of the U or at the respective junctures of the horizontal and vertical score lines 150, 152. To accommodate the in-folding of the tips 124, each of the bottom gusset panels 114 includes a pair of minor diagonal score lines 154 that extend from the edge of the panel 114 to the respective junctures (corners) of the horizontal 150 and vertical 152 score lines with the major diagonal score lines 140.

Returning now to a description of the packaging machine 10, cartons C are erected and placed on the machine mandrel 28 for indexing through the sub-processing stations, including the heating station 30, in which the bottom panels 114-118 are heated for sealing, and on to the sealing station 32, at which the bottom panels 114-118 are sealed to one another.

Mounted between the heating station 30 and the sealing station 32 is the bottom folder assembly 12. The folder assembly 12 includes a main drive shaft 36 that is oriented transverse to a plane P₃₈ defined by the rotational movement of the machine turret 38. The drive shaft 36 rotates to drive the folder assembly 12.

A pair of opposing, inwardly rotating finger assemblies 40 are operably mounted to and driven by, the drive shaft 36. The finger assemblies 40 each include a transmission (illustrated as a pair of crown or bevel gears 42) that reorients the rotational movement of the shaft 36. A spindle 44 is mounted to the gears 42, transverse to the shaft 36 and is driven by the shaft 36 through the gears 42.

From each spindle 44, a finger 45 extends generally radially from the spindle 44 to cross the path of the carton C as the carton C passes the folding assembly 12. As set forth above, each folding assembly 12 includes a pair of such finger assemblies 40, with the assemblies 40 opposing each other to contact the opposing sides 114 of the passing carton C.

The folder 12 further includes a tucking assembly 46 that is mounted to the shaft 36 between the finger assemblies 40. The tucking assembly 46 is mounted to the shaft 36 so as to rotate directly from and along with the shaft 36. The tucking assembly 46 includes a mount or extender 48 having an outer tucking blade 50 and a tab tucker 52. The tucking blade 50 tucks the trailing panel 118 under the leading panel 116 and the tab tucker 52 (which is formed similar to the blade 50) serves as an inner tucking blade to pull the sixth panel or tab 120 back to fold over the trailing panel 118 (such as that disclosed in the above-noted patent to Stacy-Ryan). The folding assembly drive shaft 36 is driven by a drive mechanism (not shown) that is operably coordinated with the overall form, fill and seal machine 10.

In order to effect the retention of the gusset tips 124 (or the folded in configuration), a pair of retaining members 54 is mounted to the drive shaft 36, between the spindles 44 and radially spaced from (and forward of) the tucker 46. The retaining members 54 are positioned on the shaft 36 so that as the shaft 36 rotates and as the fingers 45 push the gusset (triangular) panels 114 inward, the retaining members 54 engage the tips 124 of the gussets (from the inside of the container as illustrated in FIG. 11) and prevent the tips 124 from folding inward. Rather, as the fingers 45 continue to urge the gussets 114 inward, the retaining members 54 engage and hold the tips 124, folding the tips 124 outward, along the crease lines 150, 152, 154 that define the folding region 144.

In a present folder 12, each retaining member 54 includes a mount 56 that mounts the member 54 to the rotating shaft 36 and a depending extension element 58 (that contacts the gusset tip 124) extending from the mount 56. A retaining surface 60 is formed on the extension element 58 and is formed at an angle α to the gusset sides (panels) 114 of the carton C. The angled surface 60 provides a transition or inclined surface against which the gusset tip 124 bears as the gussets 114 are folded inward and the tips 124 are held out.

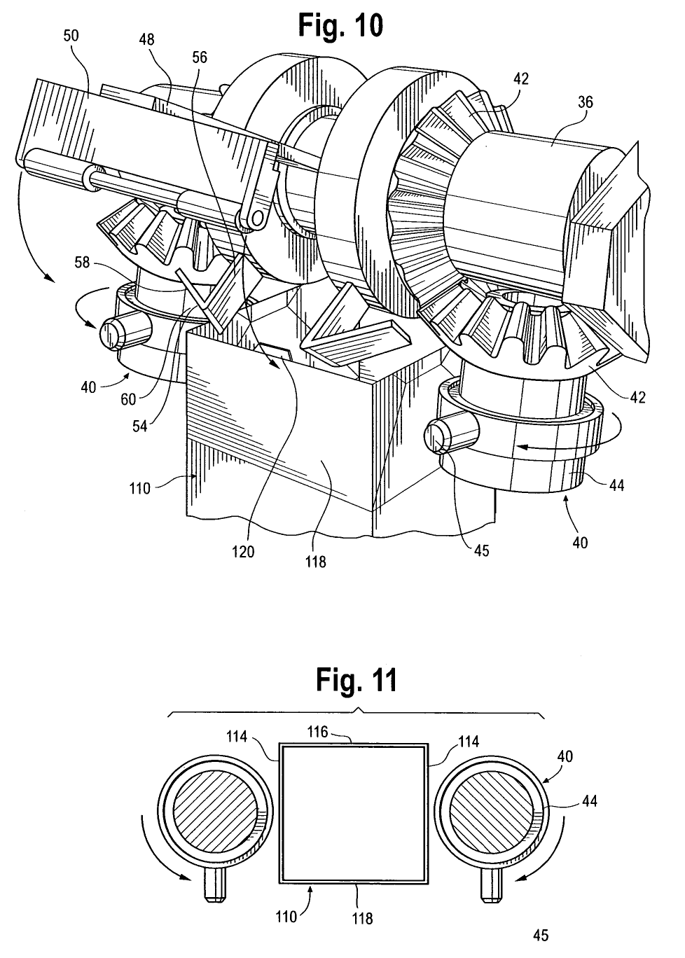

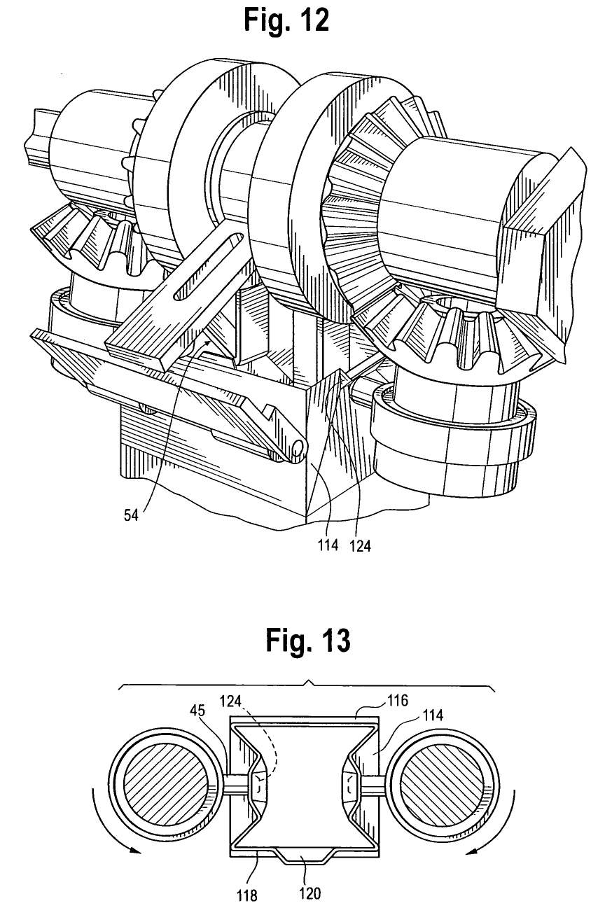

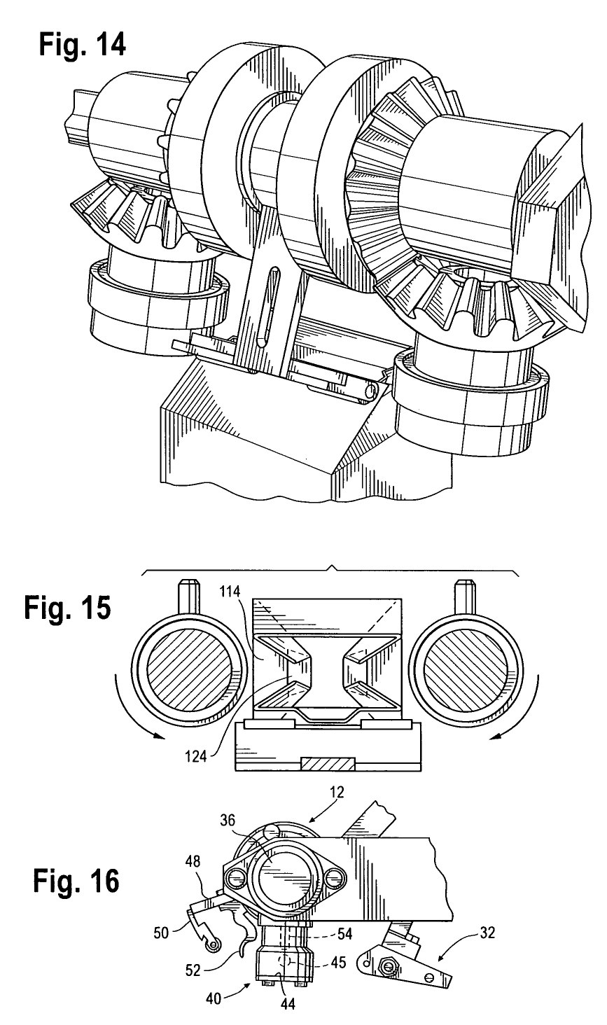

It will be appreciated by those skilled in the art from a review of FIGS. 10-12, that as the gusset panels 114 are folded inward, the overall height (or absolute distance from the crease line 136 separating the bottom wall panels 114, 116, 118 from the side wall panels 132) of the panels decreases. This is due to the infolding of the panels 114, 116, 118.

As a result of the decrease in height, the gusset tips 124 likewise move inwardly and consequently down the retaining members 54 (along surfaces 60), but are held (or retained) outward by the members 54. As a result, the gusset panels 114 are folded in while the tips 124 are held or urged outwardly. And, as the carton C progresses in the folder 12 (as illustrated in FIG. 12), the retaining members disengage from the gusset tips 124 as the trailing panel 118 is urged down on to the leading panel 116, and the retaining members 54 continue to move with the rotating shaft 36, out of and away from the carton C.

As to the operation of the bottom folder 12, as set forth above, as the carton C moves into the bottom folder 12, the folding finger assemblies 40, the retaining members 54 and the bottom tucker 46 are all out of the way of the carton C. The carton C moves into the path between the finger assemblies 40. The drive shaft 36 is timed so that the ends of the fingers 45 contact the gusset panels 114 as the retaining members 54 rotate into the interior of the carton C.

As the finger assemblies 40 continue to rotate, urging the gusset panels 114 inward, the retaining members 54 “hold” the gusset tips 124 out. The finger assemblies 40 continue to urge the gusset panels 114 in as the retaining members 54 rotate out of the carton C. However, because the tips 124 have been held or pulled out, the continued folding of the gusset panels 114 flattens the tips 124 in the folded position. As folding proceeds, the tucker blade 50 comes into contact with the trailing panel 118 and the tab tucker 52 “pulls back” on the sixth panel 120 to fold the sixth panel over at its shared edge with (fold line 142 with) the trailing panel 118. The carton C is then moved to the sealer 32 at which the panels 114, 116, 118, 120 are compressed together to form and seal the bottom wall 122.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A bottom folding assembly for forming a package having a bottom wall with in-folded gusset tips, the bottom folding assembly configured to infold the bottom gusset panels, leading panel and trailing panel of a carton and to in-fold the gusset panel tips of the bottom wall for forming a sealed carton bottom, the package being disposed on a rotating turret having a path that defines a plane, the bottom folding assembly comprising:
a rotating drive shaft mounted transverse to the turret plane and spaced from a periphery of the turret path;
a pair of opposing rotating members disposed on either side of the rotational path of the turret and operably mounted to the drive shaft, the rotating members configured to rotate in a plane that is transverse to the turret plane; and
a pair of retaining members operably mounted to the rotating drive shaft and configured to rotate with the shaft, at least a portion of each of the retaining members configured to rotate into an interior of the package and engage the gusset panel tips from the interior of the package;
wherein when a carton is positioned on the mandrel and passes the folding assembly, the opposing rotating members contact the gusset panels, urging the gusset panels inwardly as the retaining members engage the gusset tips, to prevent the gusset tips from folding inwardly with the gusset panels and folding the gusset panel tips in a direction opposite of the gusset panels.

2. The bottom folding assembly in accordance with claim 1 wherein the retaining members each include a mount fixedly mounted to the shaft and a depending extension element for rotation into the interior of the carton.

3. The bottom folding assembly in accordance with claim 2 wherein the depending extension is formed at an angle to the vertical, extending outwardly from a distal end of the extension.

4. The bottom folding assembly in accordance with claim 1 wherein ends of the retaining members rotate to define a circle that has a radius that is smaller than the distance from the shaft to the rotating fingers.

5. The bottom folding assembly in accordance with claim 1 including a tucking assembly disposed between the opposing rotating members and between the pair of retaining members, the tucking assembly mounted to the drive shaft for rotating in a plane transverse to the plane of the rotating members and parallel to the turret plane, wherein the tucking assembly contacts the bottom trailing flap, urging the bottom trailing flap inwardly, over the gusset panels.

6. A form, fill and seal packaging machine for forming a package, filling the package and sealing the package, the package being formed from a plurality of upstanding side walls, each contiguous with its adjacent side walls, the carton including a bottom wall contiguous with the upstanding side walls, the bottom wall being formed from a plurality of bottom wall flaps including a bottom leading flap, a bottom trailing flap and bottom gusset panel flaps, the packaging machine comprising:
a carton magazine for storing a plurality of cartons, the cartons being in a flat folded form and having a longitudinal side seal;
a carton erection station for receiving the cartons and opening the cartons to a tubular form;
a rotating turret, the turret rotating to define a turret plane;
a plurality of carton mandrels mounted to the turret for rotation with the turret, each mandrel configured to receive a carton in the tubular form and to carry the carton, the carton positioned on the mandrel such that a bottom of the carton is positioned at a free end of the mandrel;
a carton bottom heater located along a rotational path of the turret;
a carton bottom sealer located along the rotational path of the turret;
a carton bottom panel folding assembly located along the rotational path of the turret disposed between the carton bottom heater and the carton bottom sealer, the carton bottom panel folding assembly including a rotating drive shaft mounted transverse to the turret plane and spaced from a periphery of the turret path, a pair of opposing rotating members disposed on either side of the rotational path of the turret and operably mounted to the drive shaft, the rotating members configured to rotate in a plane that is transverse to the turret plane, and a pair of retaining members operably mounted to the rotating drive shaft and configured to rotate with the shaft, at least a portion of each of the retaining members configured to rotate into an interior of the package and engage the gusset panel tips from the interior of the package,
wherein when the carton is positioned on the mandrel and passes the folding assembly, the opposing rotating members contact the gusset panels, urging the gusset panels inwardly as the retaining members engage the gusset tips, to prevent the gusset tips from folding inwardly with the gusset panels and folding the gusset panel tips in a direction opposite of the gusset panels.

7. The form, fill and seal packaging machine in accordance with claim 6 wherein the retaining members each include a mount fixedly mounted to the shaft and a depending extension element for rotation into the interior of the carton.

8. The form, fill and seal packaging machine in accordance with claim 7 wherein the depending extension is formed at an angle to the vertical, extending outwardly from a distal end of the extension.

9. The form, fill and seal packaging machine in accordance with claim 6 wherein ends of the retaining members rotate to define a circle that has a radius that is smaller than the distance from the shaft to the rotating fingers.

10. The form, fill and seal packaging machine in accordance with claim 6 including a tucking assembly disposed between the opposing rotating members and between the pair of retaining members, the tucking assembly mounted to the drive shaft for rotating in a plane transverse to the plane of the rotating members and parallel to the turret plane, wherein the tucking assembly contacts the bottom trailing flap, urging the bottom trailing flap inwardly, over the gusset panels.
